(19) United States
(12) Patent Application Publication
(10) Pub. No.: US 2014/0173548 A1
(43) Pub. Date: Jun. 19, 2014

(54) Tool For Automation Of Functional Safety Metric Calculation And Prototyping Of Functional Safety Systems

(71) Applicant: Texas Instruments Incorporated, Dallas, TX (US)

(72) Inventors: Karl Friedrich Greb, Sugar Land, TX (US); Abhishek Arora, Austin, TX (US); Riccardo Mariani Yogitech, Calci (IT)

(73) Assignee: Texas Instruments Incorporated, Dallas, TX (US)

(21) Appl. No.: 14/020,802

(22) Filed: Sep. 7, 2013

Related U.S. Application Data
(60) Provisional application No. 61/702,017, filed on Sep. 17, 2012.

(51) Int. Cl. G06F 17/50

(52) U.S. Cl. CPC G06F 17/5081
USPC 716/136

(57) ABSTRACT

A tool for performing a functional safety analysis of an integrated circuit device tailored to a customer's specific application and implementation of the device. Information regarding a user's specific implementation of a given integrated circuit device is provided by the customer as input to the safety analysis tool. The tool then automatedly performs a functional safety analysis based on the information regarding the user's specific implementation of the integrated circuit device. In one embodiment, the customer specifies specific functional modules of the integrated circuit device, and the tool performs a functional safety analysis of the integrated circuit device that considers the functional modules selected by the user. In another embodiment, the customer specifies diagnostic measures that are implemented in the user's application of the integrated circuit device, and the tool automatedly performs a functional safety analysis of the integrated circuit device taking into account the diagnostic measures selected by the user.

### CROSS-REFERENCE TO RELATED APPLICATIONS

This application claims priority to U.S. Provisional Patent Application Ser. No. 61/702,017, filed Sep. 17, 2012, the entire contents of which is hereby incorporated by reference in its entirety.

### BACKGROUND

Functional safety is the part of the overall safety of a system or piece of equipment that depends on the system or equipment operating correctly in response to its inputs, including the safe management of likely operator errors, hardware failures and environmental changes. The principles underpinning functional safety were developed in the military, nuclear and aerospace industries, and then taken up by rail transport, process, and control industries developing sector specific standards. Functional safety standards are applied across all industry sectors dealing with safety-critical requirements.

Various standards exist that address functional safety and endeavor to set minimum functional safety standards. One such standard is IEC 61508, which is intended to be a basic functional safety standard applicable to all kinds of industry. Hundreds of additional functional safety standards exist which are based on the same principles as the IEC 61508 but are tailored for specific end equipment applications. For example, the automotive industry has developed the standard ISO 26262, entitled “Road Vehicles Functional Safety,” based on IEC 61508.

In order to meet the requirements of the relevant standards, developers of safety-critical systems may perform functional safety analyses. Such safety analyses can be used to calculate various safety metrics relating to the functional safety achieved by the system as required to show compliance with relevant functional safety standards. These metrics can include various metrics relating to a projected failure rate of the system and its constituent components as well as the effectiveness of the product architecture. Different components can have different acceptable failure rates, depending on various factors such as operating environment and function. The calculation of safety metrics necessary to prove effectiveness of safety-critical design at the integrated circuit level presents many challenges. In existing systems, functional safety analysis is typically performed manually and in many cases is not performed at all at the integrated circuit level.

### SUMMARY

One embodiment of the present invention is directed to a computer-implemented method of performing a functional safety analysis of an integrated circuit device. Pursuant to the method, information regarding a user's specific operating environment and preferred failure estimation model is received by a computing device. The computing device then automatedly performs a functional safety analysis based on the information regarding the user's specific system implementation.

Another embodiment of the present invention is directed to a computer-implemented method of performing a functional safety analysis of an integrated circuit device, wherein a computing device receives a user selection specifying functionality of the integrated circuit device to be considered in a functional safety analysis. The computing device then automatedly performs a functional safety analysis of the integrated circuit device that considers the functionality selected by the user.

Another embodiment of the present invention is directed to a computer-implemented method of performing a functional safety analysis of an integrated circuit device, wherein a computing device receives a user selection specifying diagnostic measures and safety architecture concept to be implemented in the user's system. The computing device automatedly performs a functional safety analysis of the integrated circuit device taking into account the diagnostic measures and safety architecture concept defined by the user.

### BRIEF DESCRIPTION OF THE DRAWINGS

FIG. 1 is an illustrative worksheet of a spreadsheet allowing the user to input key variables to match the operating environment of an integrated circuit device in the customer system according to a selected failure rate estimation model.

FIG. 2 is an illustrative worksheet of a spreadsheet allowing the user to select which functional modules of an integrated circuit device are to be used in implementing the desired system functionality such that customized failure rates and safety metrics can be calculated.

FIG. 3 is an illustrative worksheet of a spreadsheet allowing the user to select which safety mechanisms of the user's safety architecture concept are to be considered in the calculation of safety metrics.

FIG. 4 is an excerpt of an illustrative worksheet of a spreadsheet allowing the user to select which integrated circuit packaging elements are used to implement desired functionality and which packaging related safety mechanisms of the user's safety architecture concept are to be considered in the calculation of safety metrics and failure rate.

FIG. 5 is an excerpt of an illustrative worksheet of a spreadsheet allowing the user to add custom safety mechanisms from the user's system architecture concept to the calculation of integrated circuit safety metrics.

FIG. 6 is an illustrative worksheet of a spreadsheet providing a summary output of integrated circuit safety metric calculations according to ISO 26262.

FIG. 7 is an illustrative worksheet of a spreadsheet providing a detailed output of integrated circuit safety metric calculations according to ISO 26262.

FIG. 8 is a flowchart representing a method of performing a functional safety analysis of an integrated circuit device based on information regarding the user's specific operating environment and preferred fault estimation model in accordance with an illustrative embodiment of the present invention.

FIG. 9 is a flowchart representing a method of performing a functional safety analysis of an integrated circuit device that considers functionality of the integrated circuit device specified by the user in accordance with an illustrative embodiment of the present invention.

FIG. 10 is a flowchart representing a method of performing a functional safety analysis of an integrated circuit device taking into account the safety architecture concept implemented in the user's application of the device in accordance with an illustrative embodiment of the present invention.

FIG. 11 is a flowchart representing a method of performing architectural exploration and prototyping of a safety architecture concept by iterative usage of the tool for automated calculation of functional safety metrics in order to find a set of safety mechanisms and diagnostics which achieves target safety metrics for a given design.

FIG. 12 is a flowchart representing a method of performing architectural exploration and prototyping of safety architecture concept by iterative usage of the tool for automated calculation of functional safety metrics in order to identify a design implementation which achieves target safety metrics for a given safety architecture concept.

FIG. 13 is a flowchart representing a method of performing architectural exploration and prototyping of safety architecture concept by iterative usage of the tool for automatic calculation of functional safety metrics in order to identify a viable function selection by selection of a single functional block from a set of functional blocks which are capable of supporting a given functionality.

FIG. 14 is a flowchart representing safety concept architectural exploration and prototyping at system or integrated circuit level by calculation of safety metrics for multiple safety architecture options and selection of preferred outcome from multiple sets of analysis results

### DETAILED DESCRIPTION

The present invention is directed generally to an automated tool that allows a customer to perform customized functional safety analysis of an integrated circuit device, or a semiconductor device in a specific system usage context. For the sake of the following discussion, the terms “integrated circuit device” and “semiconductor device” will be used interchangeably. The functional safety analysis tool enables the customer to estimate failure rates for a given semiconductor device in the customer's system use case. Estimations of failure rate are often defined in terms of failures in time (FIT), which is usually defined as the number of failures that can be expected in one billion (10⁹) device-hours of operation. Embodiments of the functional safety analysis tool of the present invention also perform a failure modes, effects, and diagnostics analysis (FMEDA) that can be used to estimate the safety related performance of a semiconductor device in a specific system, with application of a specific safety architecture concept. In an illustrative embodiment, the present invention is implemented as a spreadsheet-based tool. However, other implementations of the invention are also contemplated, including graphical user interface (GUI)-based system design tools, or as part of EDA (electronic design automation) scripts in a design flow. The functional safety analysis tool of the present invention, whether implemented in spreadsheet form or otherwise, can be implemented with any type of computing device. To simplify the discussion, the description that follows will be with respect to the spreadsheet embodiment, but the inventive concepts disclosed in this specification are by no means limited to this spreadsheet embodiment.

### Failure Rate Estimation

In one embodiment of the invention, a spreadsheet tool includes a worksheet that allows the user to customize the failure rate, or FIT rate, estimation by tailoring key variables to match the utilization of the integrated circuit device in the customer system. Multiple failure rate estimation methods can be applied, with user selection of preferred estimation method or model. In an illustrative embodiment of the invention the failure rate estimation is based on IEC/TR 62380, “Reliability data handbook—Universal model for reliability prediction of electronics components, PCBs and equipment.” However, other fault models, failure rate estimation methods, or a combination thereof can be used in accordance with the present invention. In an illustrative embodiment of the invention, the input variables that can be tailored are:
Package Used
Customer Input for Transient Fault Estimation
Maximum Power Dissipation
Assumed Lifetime
Confidence Level
Operational Profile

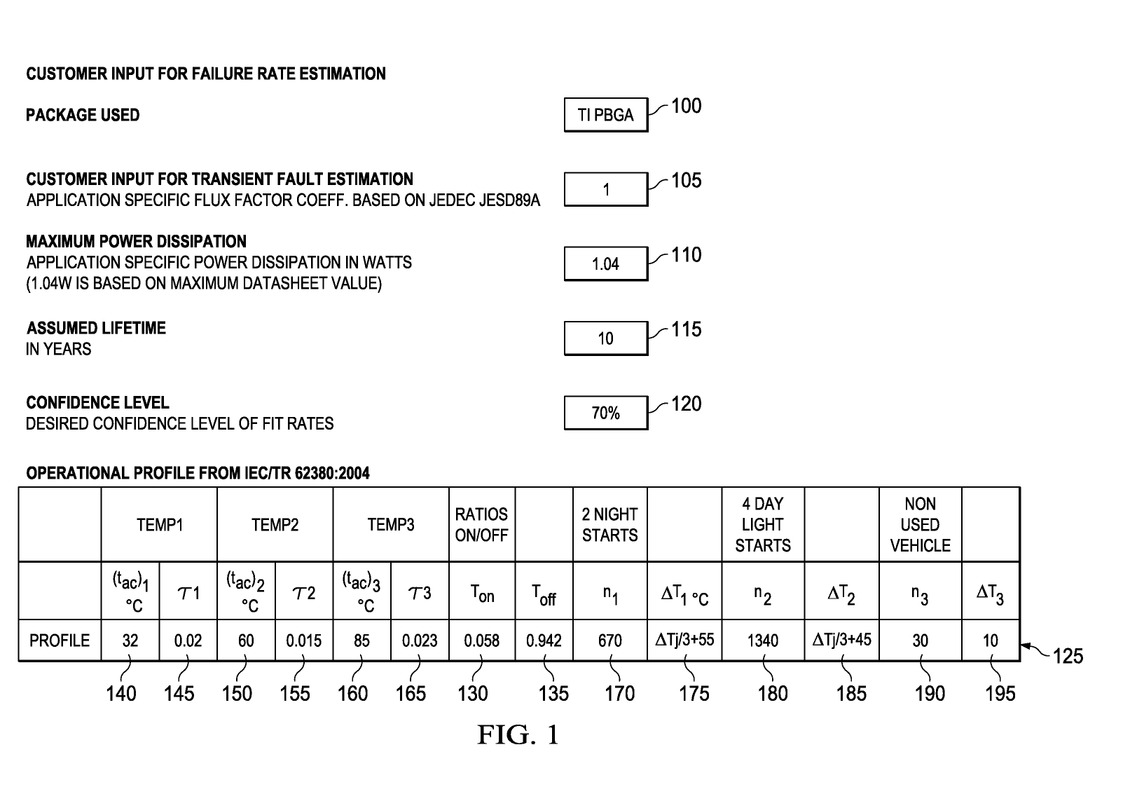

FIG. 1 is an illustrative worksheet of a spreadsheet allowing the user to input key variables to match the utilization of the integrated circuit device in the customer system. The input variables in the worksheet of FIG. 1 are illustrative only and the invention is not in any way limited to these specific input variables. The user can select among available integrated circuit package types using the “Package Used” field 100. FIG. 1, for example, shows that a plastic ball grid array (PBGA) package has been specified. Different package types exhibit different thermal management characteristics and therefore impact estimated failure rates differently.

The user can input a neutron flux factor for the end equipment operating environment using the “Customer Input for Transient Fault Estimation” field 105. Neutron flux is related to cosmic particle strikes, which varies by geographical location. The neutron flux factor is defined by the JEDEC JESD89A standard and reflects the strength of neutron radiation found in a specific location. In an exemplary embodiment, the default value is “1,” which corresponds to measured neutron flux recorded in New York City, USA, as per the JEDEC JESD89A standard. The JEDEC JESD89A provides guidance on neutron flux values for several worldwide locations as well as references to online databases with additional locations. As the flux factor increases, the silicon transient failure rate estimation will increase.

The “Maximum Power Dissipation” field 110 allows the user to input the worst usage case power dissipated. The maximum power dissipated impacts both package failure rate and silicon permanent failure rate. In an illustrative embodiment, the worksheet has a default value that represents the worst case power dissipation from the semiconductor's respective family superset architecture data sheet, as to the time of publication. The user can set this value based on worst case power dissipation observed in system testing. Alternatively, the data sheet value for the particular device can be utilized. Reducing the maximum power dissipated results in a reduction in package FIT and silicon permanent FIT when using the IEC/TR 62380 failure rate estimation models.

The user can input the assumed product lifetime of the semiconductor using the “Assumed Lifetime” field 115. This value is utilized to translate failure rates into probabilities of failure over a specific time span. In an illustrative embodiment of the invention, this field has a default value. For example, the default value could be 10 years.

The “Confidence Level” field 120 allows the user to input a desired confidence level for the base failure rate data. Databook data, such as the IEC/TR 62380, is considered conservative per commentary in many functional safety standards. ISO 26262-5, Annex F, note 3, suggests that the confidence level of the major data books, such as IEC/TR 62380, should be considered to be 99%. By altering the confidence level field 120, the user can scale the base failure rate per element as needed to match failure rate data of other components in the system design. As confidence level decreases from 99%, the base failure rates will decrease. As 70% confidence level is a common industry standard, the spreadsheet uses this as a default value in one embodiment of the invention.

The user can change the operational profile of the integrated circuit device to match application conditions by modifying the “Operational Profile” fields 125. IEC/TR 62380 defines operational profile based on the operating phases of the device in terms of ambient temperature and “on time” duty cycle. Thus, in one embodiment of the invention, the operational profile 125 comprises fields Tₒₙ 130 and T_{off} 135. Tₒₙ 130 represents the projected percentage of time that the semiconductor device is active, and T_{off} 135 represents the projected percentage of time that the semiconductor device is inactive. In a further illustrative embodiment. The operational profile 125 comprises fields (t_{ac})₁ 140, (t_{ac})₂ 150, (t_{ac})₃ 160, τ1 145, τ2 155, and τ3 165. τ1 145 represents the projected percentage of time that the integrated circuit device is active at temperature (t_{ac})₁ 140. Thus in the example shown in FIG. 1, the integrated circuit device is projected to be active 2% of the time at a temperature (t_{ac})₁ of 32° C. Similarly, the integrated circuit device is projected to be active 1.5% of the time (τ2 155) at a temperature (t_{ac})₂ 150 of 60° C., and 2.3% of the time (τ3 165) at a temperature (t_{ac})₃ 160 of 85° C.

In addition, the number of operational cycles per year starting from an initial temperature are considered. In FIG. 1, ΔT₁ 175, ΔT₂ 185 and ΔT₃ 195 represent the delta between initial start temperature and junction temperature. Thus field n₁ 170 represents the projected operational cycles per year with a temperature difference ΔT₁ 175, field n₂ 180 represents the projected operational cycles per year with a temperature difference ΔT₂ 185, and field n₃ 190 represents the projected operational cycles per year with a temperature difference ΔT₃ 195. In an illustrative embodiment of the invention, the operational profile 125 comes preloaded with default values. The user can select to modify the profile based on their application conditions. Several operational profiles may be found in the IEC TR 62380 standard. Increasing the “on time” duty cycle or the ambient temperature will result in increased silicon permanent failure rate. Increasing the number of start events or the delta between initial temperature and junction temperature will result in an increase in package failure rate.

### Product Function Tailoring

In an illustrative embodiment of the present invention, the spreadsheet includes a worksheet that allows the user to customize the failure rate estimation by tailoring the analysis to respect only the silicon which is being utilized by the user's application to implement the desired system functionality. Items that are selected are used in the calculation of safety metrics for the safety function and goal. Items that are not selected will be considered not safety related logic for the safety function and safety goal under calculation, and therefore are not used in the calculation of safety metrics. In an illustrative embodiment of the invention, some of the input variables that can be tailored are:
Amount of CPU SRAM Utilized
Amount of CPU Flash Memory Utilized
Amount of flash EEPROM Emulation Memory Utilized
Modules Utilized for Safety Function and Goal

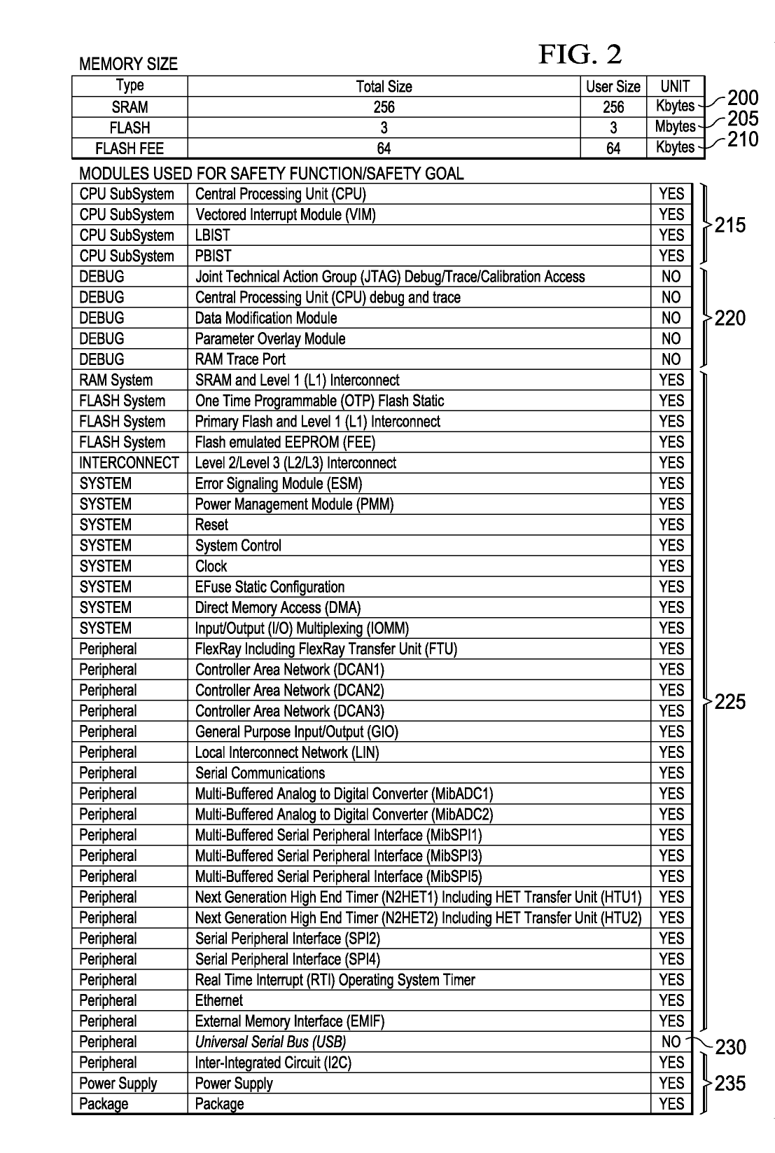

FIG. 2 is an illustrative worksheet of a spreadsheet allowing the user to select which functional modules of the integrated circuit device are to be considered in the calculation of safety metrics and failure rate. The spreadsheet allows the user to select the amount of memory that is safety related for the realization of the target safety function or safety goal. The “SRAM” field 200, “FLASH” field 205, and “FLASH-FEE” field 210 allow selection of the amount of SRAM, Flash, and Flash EEPROM emulation memory that is utilized. In an illustrative embodiment, the default amounts in the spreadsheet represent the full amount of memory available on the family superset architecture. The failure rate of the integrated circuit device will be reduced if the amount of memory utilized is reduced.

In addition, the product function tailoring worksheet enables the user to select which modules are safety related using the “Modules used for Safety Function and Safety Goal” fields shown in FIG. 2. In an illustrative embodiment of the invention, the various functional modules available on the family superset architecture are listed in the spreadsheet along with a user input field allowing the user to indicate whether or not the corresponding functional module is safety related and therefore should be considered in the calculation of failure rate and safety metrics. Thus the user can input either “YES” (safety related) or “NO” (not safety related) in these fields. In an exemplary embodiment, by default, all debug subsystem modules are considered not safety related. Thus in the example represented by FIG. 2, input fields 220 corresponding to the debug subsystem modules are marked “NO.” Also marked “NO” is the USB field 230. All remaining modules are considered safety related and are therefore the corresponding input fields 215, 225 and 235 are marked “YES.” The estimated failure rate of the semiconductor device will be reduced if the number of safety related modules is reduced.

### Safety Mechanism Tailoring

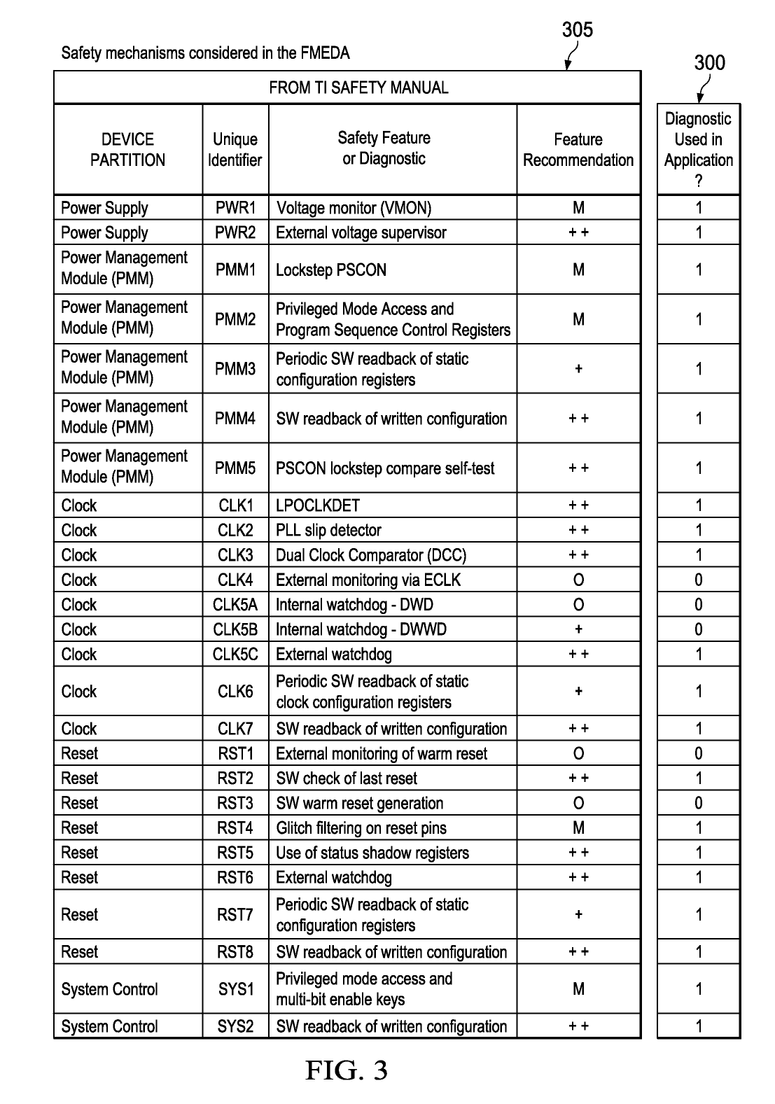

In an illustrative embodiment of the present invention, the spreadsheet also includes a worksheet which allows the user to customize the safety metric calculation by selecting which safety mechanisms listed in the device safety manual have been implemented in the application. FIG. 3 is an illustrative worksheet of a spreadsheet allowing the user to select which safety mechanisms of the integrated circuit device are to be considered in the calculation of safety metrics and failure rate. In an illustrative embodiment of the invention, the various safety mechanisms available on the integrated circuit device (as listed in the device's safety manual) are listed in the spreadsheet along with a user input field allowing the user to indicate whether or not the corresponding safety mechanism is implemented in the customer's application and should therefore be considered in the calculation of estimated failure rate and safety metrics. In the illustrative embodiment represented by FIG. 3, the user indicates whether a given safety diagnostic measure is utilized in the application by entering either a “0” (diagnostic not utilized) or a “1” (diagnostic utilized) in the user input column 300. It will be understood that a typical safety mechanism tailoring worksheet according to the present invention will have many more rows than are depicted in FIG. 3. FIG. 3 only shows a limited number of rows for purposes of illustration of the invention.

In an illustrative embodiment of the invention, the safety mechanism tailoring worksheet also includes a “feature recommendation” column 305. This is not a user input field but is instead preset to indicate the product's safety manual recommendation regarding whether the corresponding safety feature or diagnostic tool should be implemented. In an exemplary embodiment, the feature recommendation field 305 will contain one of four designations: O (optional), + (recommended), ++ (highly recommended), or M (mandatory). For safety features that are designated “mandatory,” the user input field 300 is preset at “1” and cannot be toggled by the user. Conversely, for some safety manual recommendations, the toggle field is colored grey and set at “0”. This indicates a recommendation that is not used in the calculation of metrics by this spreadsheet. The safety metrics for the semiconductor will improve or reduce dependent on the number and effectiveness of diagnostics utilized.

### Pin-Level Tailoring

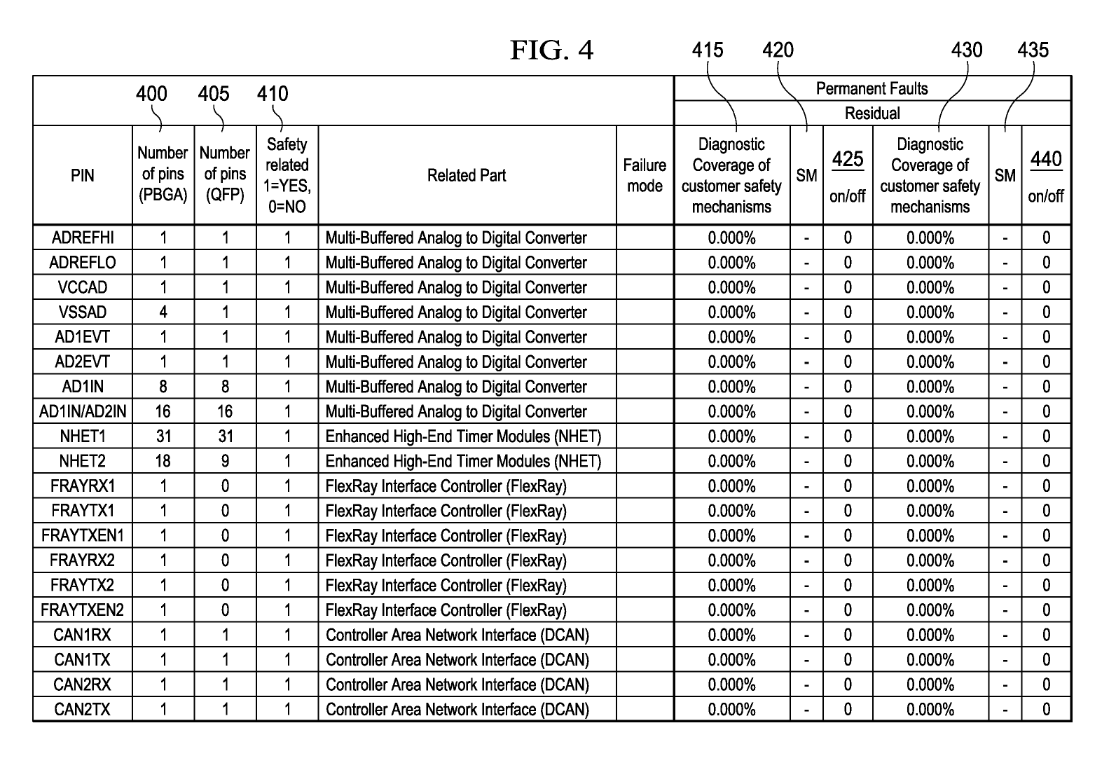

In an illustrative embodiment of the present invention, the spreadsheet also includes a worksheet which allows the user to tailor the usage of the device pins, balls, and package diagnostics in the analysis to match the utilization in the customer application. FIG. 4 is an excerpt of an illustrative worksheet of a spreadsheet allowing the user to select which pins, balls, and package diagnostics of the integrated circuit device are to be considered in the calculation of safety metrics and failure rate. In the exemplary embodiment represented by FIG. 4, there are two integrated circuit package types available: a plastic ball grid array (PBGA) package and a Quad Flat Package (QFP). The user can select which device pins are safety related on the PBGA package by modifying the “Number of Pins (PBGA)” field 400. For the QFP package, the user can modify the “Number of Pins (QFP)” field 405. Each possible terminal of the device is listed as a separate row in the worksheet. It will be understood that a typical pin-level tailoring worksheet according to the present invention will have many more rows than are depicted in FIG. 4. FIG. 4 only shows a limited number of rows for purposes of illustration of the invention. The fields 405 and 410 represent the number of pins that are safety related for the safety function and safety goal metric. The “Safety Related” field 410 allows the user to indicate whether the pin or ball is safety related and should therefore be considered in the functional safety analysis. If a pin or ball is safety related, this can be indicated by entering “1” in field 410. If the pin or ball is not safety related, this can be indicated by entering “0” in field 410. For certain functions, such as power rails, ground rails, and multiple input busses, the number of pins related to the functions that are safety related can be entered in the “number of pins” fields 400 and 405.

According to an illustrative embodiment of the invention, the worksheet of FIG. 4 also allows the user to select what system or application level diagnostics are utilized relative to a given pin (or ball) to provide package coverage beyond the safety manual measures already selected in the “Safety Mechanisms Tailoring” worksheet of FIG. 3. In an illustrative embodiment of the invention, fields are available to enter two diagnostics for residual faults and two diagnostics for latent faults. For ease of illustration, FIG. 4 only shows the input fields (415-440) for residual faults. The input fields for latent faults (not illustrated) are largely analogous to the input fields for residual faults. As mentioned, the worksheet of FIG. 4 includes fields for entering two diagnostic measures for residual faults. Input fields 415, 420, and 425 are provided for a first diagnostic measure, and fields 430, 435, and 440 are provided for a second diagnostic measure. The “Diagnostic Coverage of Customer Safety Mechanisms” fields 415 and 430 allow the user to input the effectiveness of an implemented diagnostic. This value should range between 0% and 100%. The user can input a unique text identifier for the safety mechanism using the “SM” fields 420 and 435. The “ON/OFF” fields 425 and 440 allow the user to select to activate or deactivate the respective diagnostic measure. A value of 0 indicates a deactivated diagnostic, while a value of 1 indicates an active diagnostic.

### Custom Diagnostics

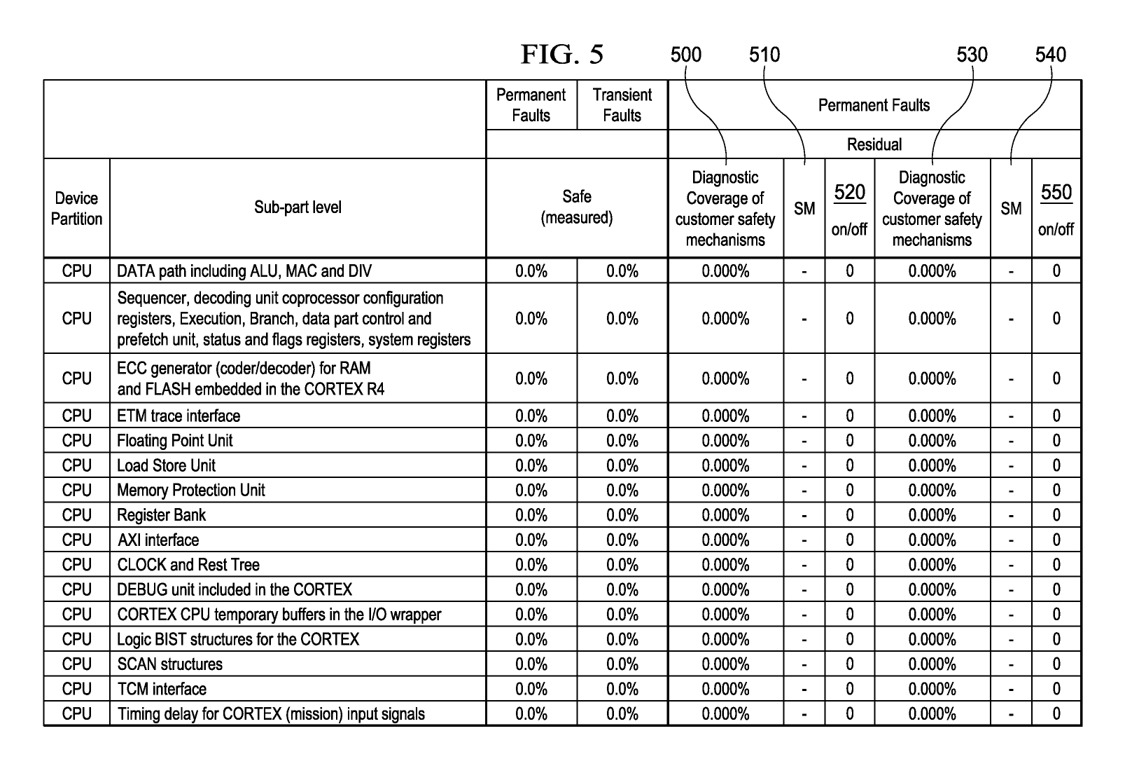

In an illustrative embodiment of the invention, the spreadsheet also includes a worksheet that allows the user to add user specified diagnostics to the calculation of safety metrics, beyond those that are described in the safety manual of the product. FIG. 5 is an excerpt of an illustrative worksheet of a spreadsheet allowing the user to add custom diagnostic measures to the calculation of safety metrics. Each row in the custom diagnostics worksheet corresponds to a different sub-part level of the integrated circuit device. It will be understood that a typical custom diagnostics worksheet according to the present invention will have many more rows than are depicted in FIG. 5. FIG. 5 only shows a limited number of rows for purposes of illustration of the invention.

In an illustrative embodiment of the custom diagnostics worksheet, fields are available to enter two user-defined diagnostic measures for permanent residual faults, two user-defined diagnostic measures for permanent latent faults, and two user-defined diagnostic measures for transient residual faults. For ease of illustration, FIG. 5 only shows the input fields (500-550) for permanent residual faults. The input fields for permanent latent faults and transient residual faults (not illustrated) are largely analogous to the input fields for permanent residual faults. As mentioned, the worksheet of FIG. 5 includes fields for entering two user-defined diagnostic measures for residual faults. Input fields 500, 510, and 520 are provided for a first custom diagnostic measure, and fields 530, 540, and 550 are provided for a second custom diagnostic measure. The “Diagnostic Coverage of Customer Safety Mechanisms” fields 500 and 530 allow the user to input the effectiveness of an implemented user-defined diagnostic. This value should range between 0% and 100%. The user can input a unique text identifier for the custom safety mechanism using the “SM” fields 420 and 435. The “ON/OFF” fields 425 and 440 allow the user to select to activate or deactivate the respective user-defined diagnostic measure. A value of 0 indicates a deactivated diagnostic, while a value of 1 indicates an active diagnostic.

As previously alluded to, in an illustrative embodiment of the present invention, the custom diagnostics worksheet includes additional columns which, for purposes of clarity of illustration, are not shown in FIG. 5. In addition to those already mentioned, pertaining to input fields for permanent latent faults and transient residual faults, the custom diagnostics worksheet may also include non-user-input columns pertaining to FMEDA line number, type, part level, and device partition.

### Functional Safety Analysis Summary

Using the data, metrics and settings input by the user as described above, the spreadsheet tool of the present invention automatedly performs a functional safety analysis of the integrated circuit device in question. The functional safety analysis can involve the calculation of various safety metrics including failure rate estimation (FIT) data. In accordance with an illustrative embodiment of the invention, the calculation of safety metrics including failure rate data is performed in accordance with one or more industry standard functional safety standards, such as, for example, IEC 61508 or ISO 26262. In an illustrative embodiment of the invention, the user can select which industry standard functional safety model should be used to perform the calculation of safety metrics.

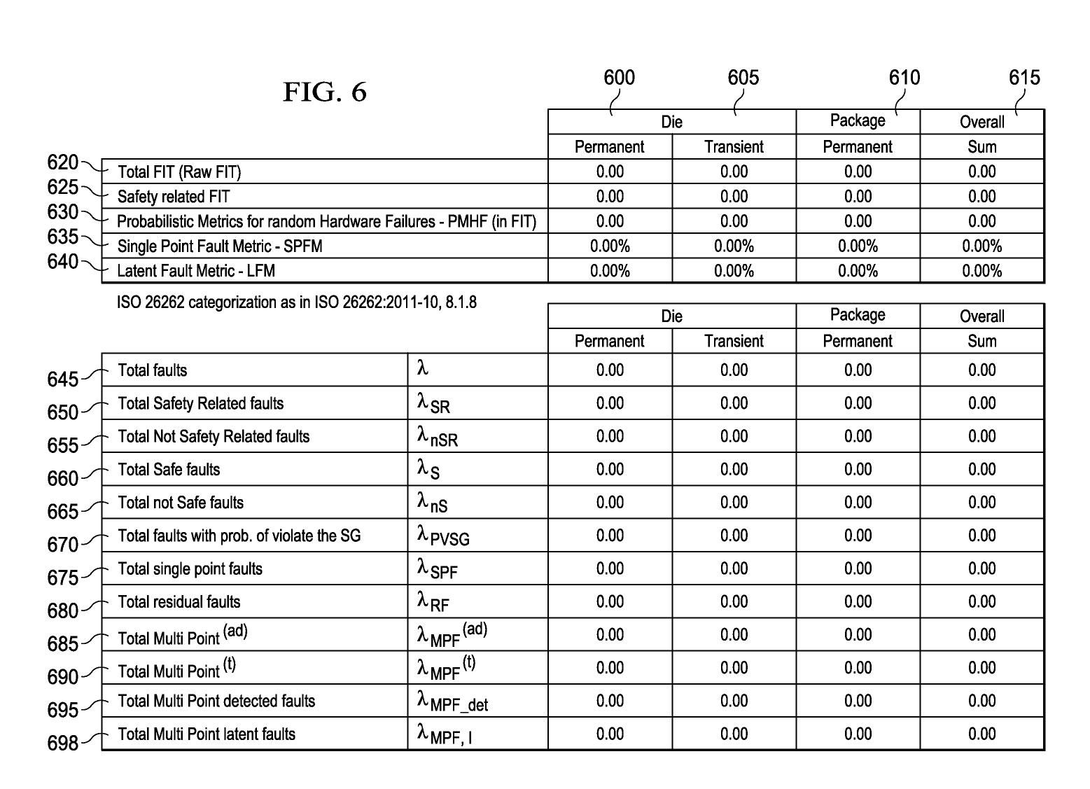

According to an embodiment of the invention, the spreadsheet tool includes a worksheet that provides a summary output of the safety metric calculations. Multiple summary output worksheets can be provided if more than one standard is used to calculate safety metrics. FIG. 6 is an illustrative worksheet of a spreadsheet providing a summary output of safety metric calculations according to ISO 26262. As can be seen in FIG. 6, several points of data are provided. The summary worksheet breaks the failure rate data out by permanent die faults (column 600), transient die faults (column 605), package faults (permanent) (column 610), and also indicates the sum (overall) failure rate (column 615). For each of these categories, the summary worksheet provides total FIT data 620, safety-related FIT 625, probabilistic metrics for random hardware failures 630, single point fault metrics 635, and latent fault metrics 640. The summary worksheet further breaks the total FIT data down by ISO 26262 failure rate class, such as single-point faults, multi-point faults, and other fault classes, in rows 645-698.

As mentioned, according to an embodiment of the invention, summary worksheets are also provided summarizing fault metrics calculated according to other standards, such as IEC 61508.

### Functional Safety Analysis Details

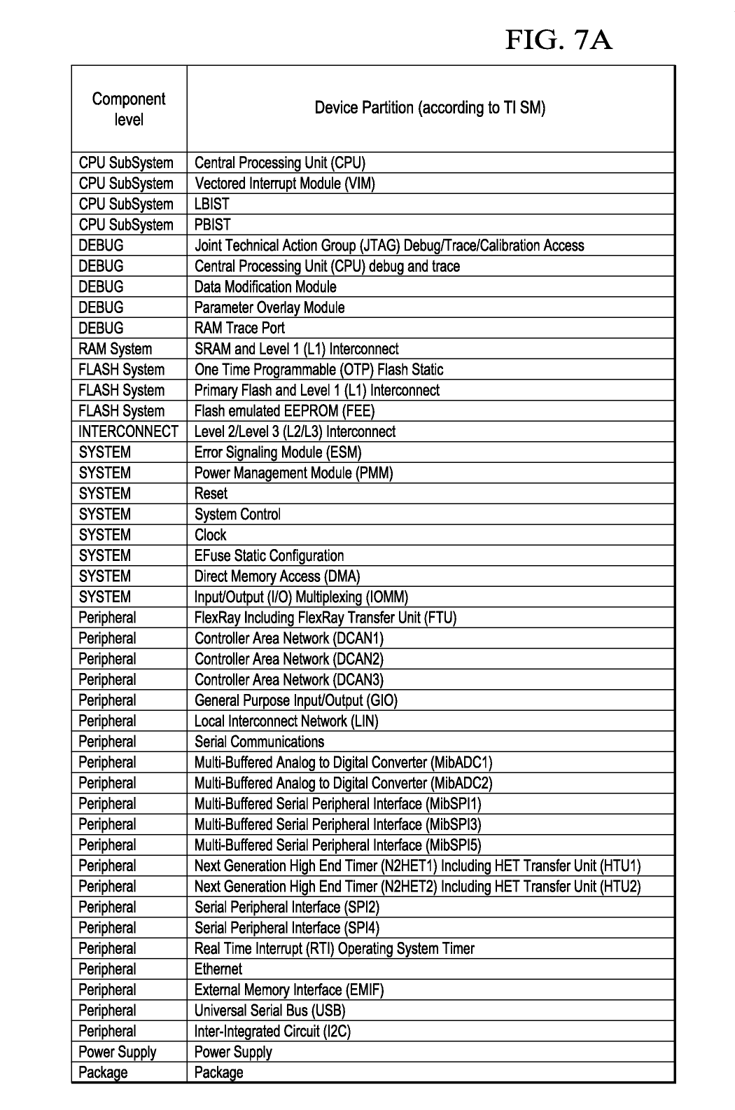

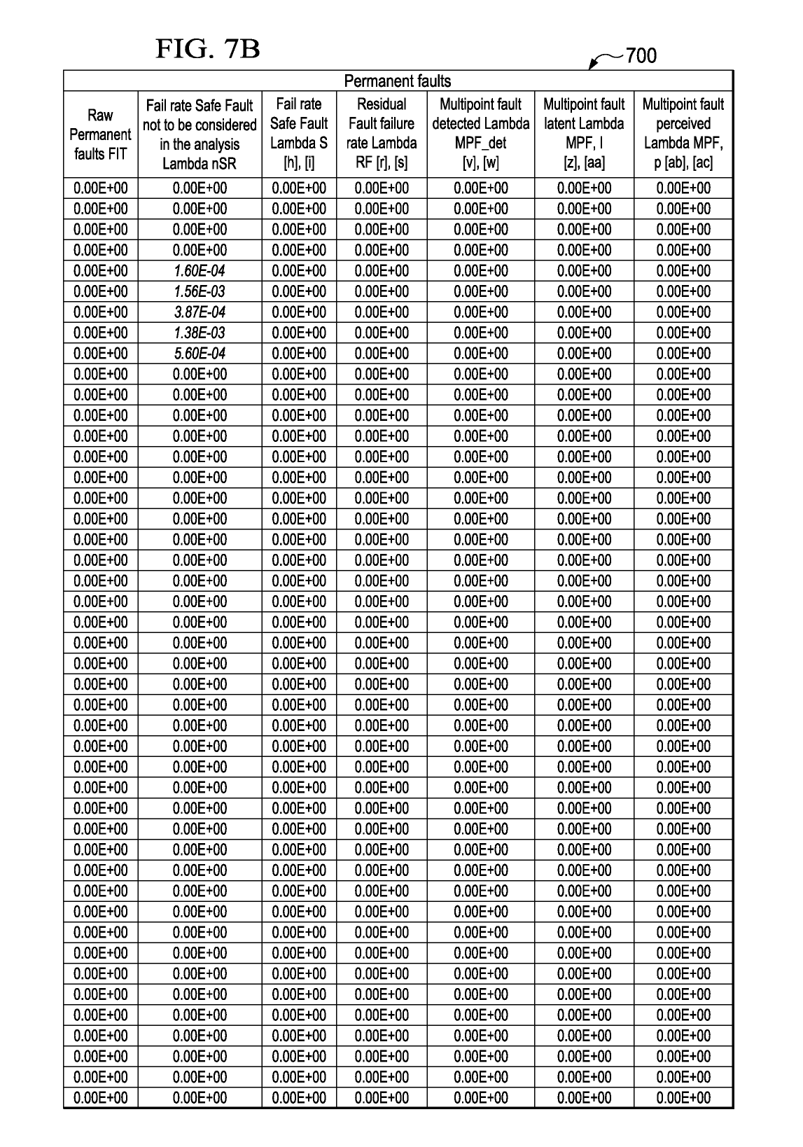

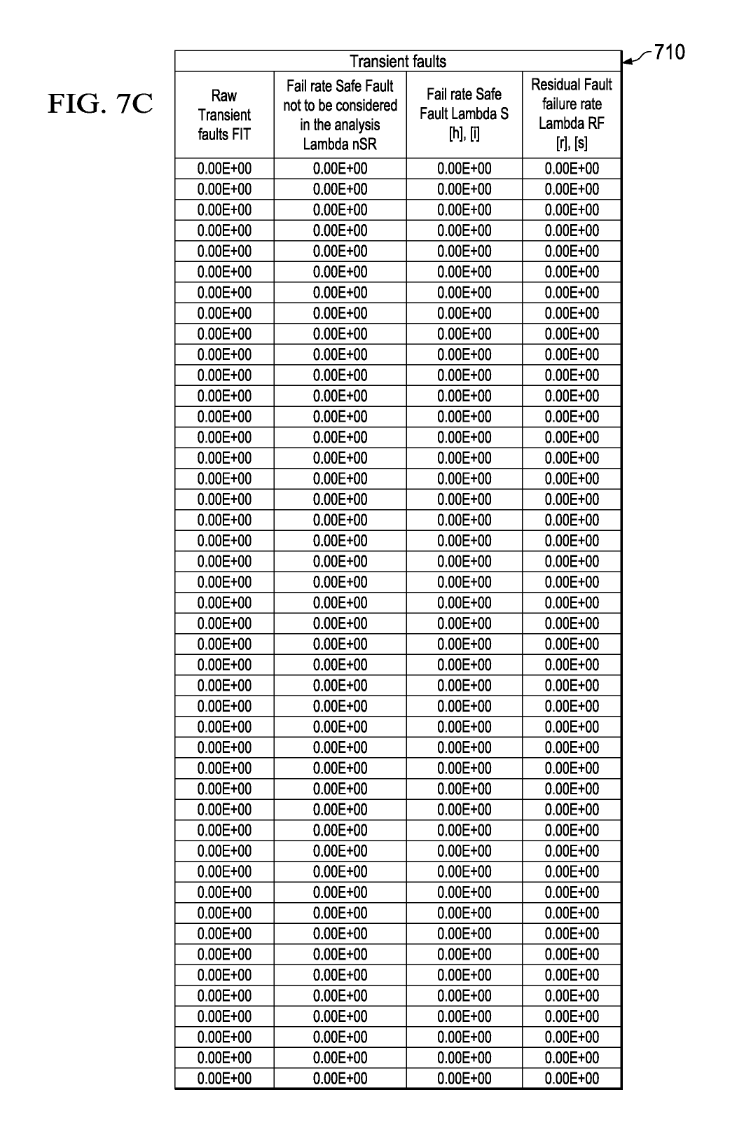

According to an embodiment of the invention, the spreadsheet tool includes a worksheet that provides a detailed output of the safety metric calculations. Multiple summary output worksheets can be provided if more than one standard is used to calculate safety metrics. FIG. 7 is an illustrative worksheet of a spreadsheet providing a detailed output of safety metric calculations according to ISO 26262. As can be seen in FIG. 7, the data provided in the summary output worksheet is further broken down into separate functional modules of the integrated circuit device. In one embodiment of the invention, the modules listed in the rows of the detailed output worksheet correspond to the modules listed in the product function tailoring worksheet of FIG. 2. The columns further break the failure rate data down per module for permanent faults per ISO 26262 failure rate class (columns 700), as well as for transient faults per ISO 26262 failure rate class (columns 710). According to an embodiment of the invention, detailed output worksheets are also provided detailing fault metrics calculated according to other standards, such as IEC 61508.

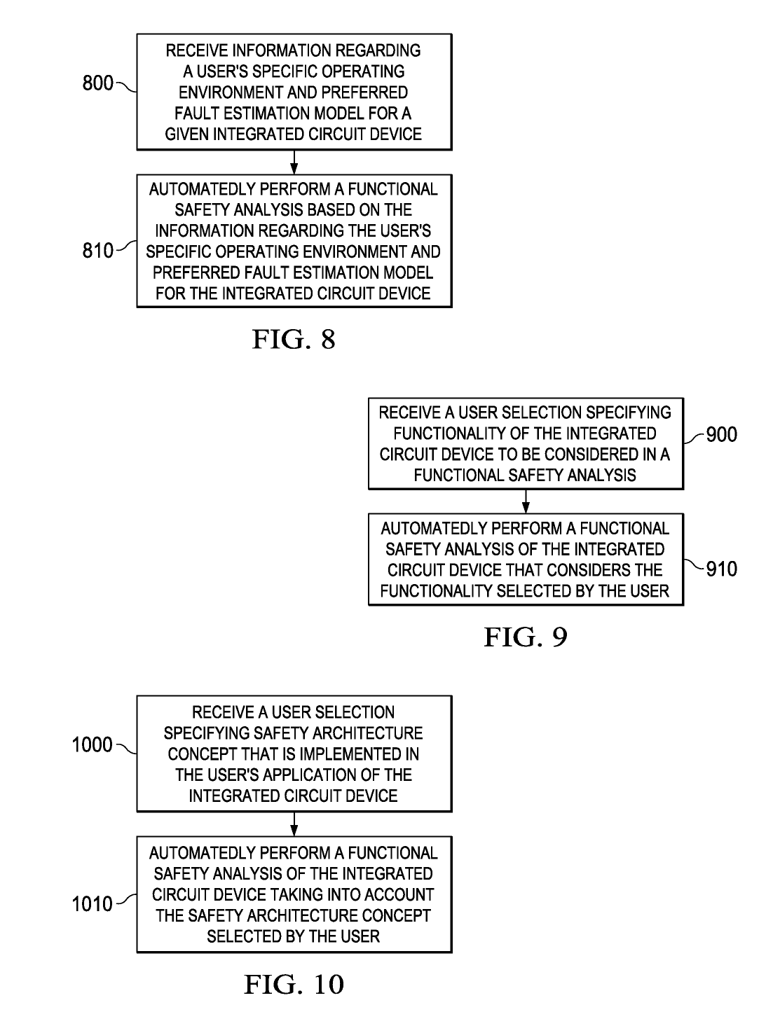

FIG. 8 is a flowchart representing a method of performing a functional safety analysis of an integrated circuit device based on information regarding the user's specific system implementation in accordance with an illustrative embodiment of the present invention. At block 800, information regarding a user's specific implementation of a system integrating the given integrated circuit device is received by a computing device. At block 810, the computing device automatedly performs a functional safety analysis based on the information regarding the user's specific system implementation integrating the integrated circuit device.

FIG. 9 is a flowchart representing a method of performing a functional safety analysis of an integrated circuit device that considers functional modules of the integrated circuit device specified by the user in accordance with an illustrative embodiment of the present invention. At block 900, a computing device receives a user selection specifying functional modules of the integrated circuit device to be considered in a functional safety analysis. At block 910, the computing device automatedly performs a functional safety analysis of the integrated circuit device that considers the functional modules selected by the user.

FIG. 10 is a flowchart representing a method of performing a functional safety analysis of an integrated circuit device taking into account diagnostic measures implemented in the user's application of the device in accordance with an illustrative embodiment of the present invention. At block 1000, a computing device receives a user selection specifying diagnostic measures that are implemented in the user's application of the integrated circuit device. At block 1010, the computing device automatedly performs a functional safety analysis of the integrated circuit device taking into account the diagnostic measures selected by the user.

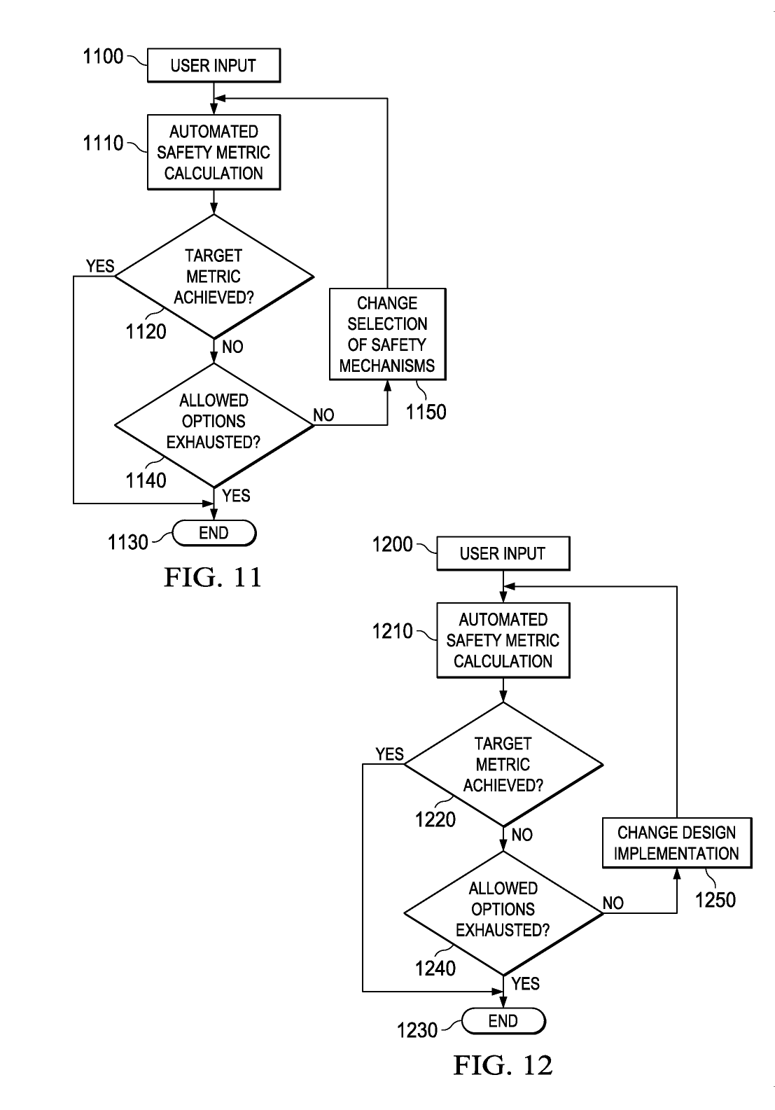

FIG. 11 is a flowchart representing a method of performing a functional safety analysis for the purposes of safety architecture concept exploration and prototyping in accordance with an illustrative embodiment of the present invention. Such exploration could be performed at either the system or the integrated circuit level of abstraction. At block 1100, a computing device receives a user selection specifying the intended operating environment, functionality, safety architecture concept (selected safety mechanisms from a set of available safety mechanisms), and target safety metrics. At block 1110, the computing device automatedly performs a functional safety analysis of the planned system implementation incorporating the integrated circuit device taking into account the user input. At block 1120, the computing device compares the resulting safety metrics to the target metrics to determine if the safety architecture concept has achieved the target safety metrics. If target safety metrics are met, the method completes at block 1130. If target safety metrics are not met, the method proceeds to block 1140, in which it is determined if other safety mechanisms or combinations of safety mechanisms available in the set of allowed safety mechanisms have yet to be tried. If all accepted options have been exhausted, the method proceeds to completion in block 1130. If remaining safety mechanisms or combinations of safety mechanisms remain which have not yet been tried, the safety concept input is modified in block 1150 by changing the selection of safety mechanisms and diagnostics defined in the safety architecture concept. The selection of safety mechanisms and diagnostics from the safety architecture concept can be done manually by user or can be done in an automated fashion by the computing device until all possible permutations are exhausted. The method then proceeds to block 1110 where the safety analyses are re-executed and the process continues until target metrics are achieved or all accepted safety mechanism combinations have been tried.

FIG. 12 is a flowchart representing a method of performing a functional safety analysis for the purposes of safety architecture concept exploration and prototyping in accordance with an illustrative embodiment of the present invention. Such exploration could be performed at either the system or the integrated circuit level of abstraction. At block 1200, a computing device receives a user selection specifying the intended operating environment, functionality, safety architecture concept, and target safety metrics. At block 1210, the computing device automatedly performs a functional safety analysis of the planned implementation of the integrated circuit device taking into account the user input. At block 1220, the computing device compares the resulting safety metrics to the target metrics to determine if the safety architecture concept has achieved the target safety metrics. If target safety metrics are met, the method completes at block 1230. If target safety metrics are not met, the method proceeds to block 1240, in which it is determined if there are other allowed physical implementations of the functional logic which have not yet been tried. For example, functional logic implemented as hardware description language (HDL) could be synthesized with a different set of synthesis parameters within an allowable set. If all allowed options have been exhausted, the method proceeds to completion in block 1230. If remaining implementation options exist which have not yet been tried, the safety concept input is modified in block 1250 by changing the selection of input related to the design implementation. This selection can be done manually by user or can be done in an automated fashion by the computing device until all possible permutations are exhausted. The method then proceeds to block 1210 where the safety analyses are re-executed and the process continues until target metrics are achieved or all implementation options have been tried.

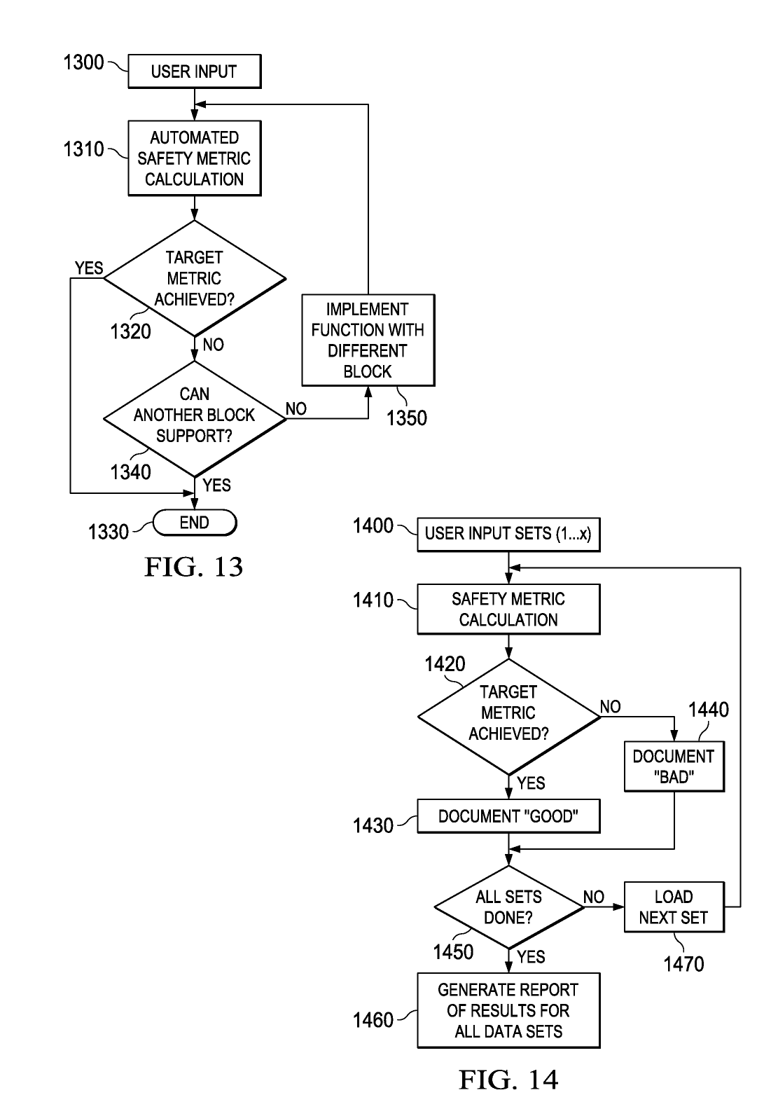

FIG. 13 is a flowchart representing a method of performing a functional safety analysis for the purposes of safety architecture concept exploration and prototyping in accordance with an illustrative embodiment of the present invention. Such exploration could be performed at either the system or the integrated circuit level of abstraction. At block 1300, a computing device receives a user selection specifying the intended operating environment, functionality (from a set of device blocks which can implement the desired function), safety architecture concept, and target safety metrics. At block 1310, the computing device automatedly performs a functional safety analysis of the planned implementation of the integrated circuit device taking into account the user input. At block 1320, the computing device compares the resulting safety metrics to the target metrics to determine if the safety architecture concept has achieved the target safety metrics. If target safety metrics are met, the method completes at block 1330. If target safety metrics are not met, the method proceeds to block 1340, in which it is determined if there are other unused blocks on the device which could be used to implement the desired functionality and which have not yet been tried. For example, a sensor interface function could be realized via multiple types of serial peripherals such as Ethernet, CAN, or UART peripherals. If all allowed options have been exhausted, the method proceeds to completion in block 1330. If remaining options exist which have not yet been tried, the safety concept input is modified in block 1350 by changing the selection of input related to the block implementing desired functionality. This selection can be done manually by user or can be done in an automated fashion by the computing device until all possible permutations are exhausted. The method then proceeds to block 1310 where the safety analyses are re-executed and the process continues until target metrics are achieved or all functionality options have been tried.

FIG. 14 is a flowchart representing a method of performing a functional safety analysis for the purposes of safety architecture concept exploration and prototyping in accordance with an illustrative embodiment of the present invention. Such exploration could be performed at either the system or the integrated circuit level of abstraction. At block 1400, a computing device receives a user selection specifying multiple sets of data including the intended operating environment, functionality, safety architecture concept, and target safety metrics. At block 1410, the computing device automatedly performs a functional safety analysis of the planned implementation of the integrated circuit device taking into account the user input. At block 1420, the computing device compares the resulting safety metrics to the target metrics to determine if the safety architecture concept has achieved the target safety metrics. If target safety metrics are met, the method proceeds to block 1430 where the input set is marked as “good”. If target safety metrics are not met, the method proceeds to block 1440, in which the input set is marked as “bad.” In either case, the method proceeds to block 1450, in which it is determined if all input sets have been processed. If all input sets are processed, then the method proceeds to block 1460 in which an output report is generated detailing “good” and “bad” input sets with their results and the method ends. If all input sets are not complete, the method moves to block 1470 in which a new input set is loaded and the method proceeds to block 1410. When the method is complete, the user can select a preferred option for implementation from the set of “good” results.

Having thus described a computer-implemented method of performing a functional safety analysis of an integrated circuit device by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Accordingly, it is appropriate that the appended claims be construed broadly and in a manner consistent with the broad inventive concepts disclosed herein.

What is claimed is:

1. A computer-implemented method of performing a functional safety analysis of an integrated circuit device, the method comprising:
receiving, with a computing device, information regarding a user's specific utilization of a given integrated circuit device; and
automatedly performing, with the computing device, a functional safety analysis based on the information regarding the user's specific utilization of the integrated circuit device.

2. The method of claim 1, wherein said information regarding the user's specific utilization of the integrated circuit device comprises information tending to have an effect on a failure rate of the integrated circuit device.

3. The method of claim 1, wherein said information regarding the user's specific utilization of the integrated circuit device comprises information regarding environmental conditions corresponding to the user's intended usage of the integrated circuit device.

4. The method of claim 1, wherein automatedly performing a functional safety analysis comprises calculating safety metrics of the integrated circuit device based on the information regarding the user's specific utilization of the integrated circuit device.

5. The method of claim 4, further comprising:
comparing, with the computing device, a calculated safety metric of the integrated circuit device to a target safety metric; and
if the target safety metric is not achieved, automatedly changing, with the computing device, an aspect of the user's specific utilization, and automatedly performing, with the computing device, a functional safety analysis based on the changed information regarding the user's specific utilization of the integrated circuit device.

6. The method of claim 1, wherein automatedly performing a functional safety analysis comprises calculating estimated failure rate data for the integrated circuit device based on the information regarding the user's specific utilization of the integrated circuit device.

7. The method of claim 1, wherein automatedly performing a functional safety analysis comprises calculating estimated failure rate data for specified functional modules of the integrated circuit device based on the information regarding the user's specific utilization of the integrated circuit device.

8. The method of claim 1, wherein the functional safety analysis is performed in accordance with one or more industry standard reliability models.

9. The method of claim 8, further comprising receiving, with the computer device, a user selection of a specified industry standard reliability model, and wherein the functional safety analysis is performed in accordance with the industry standard reliability model selected by the user.

10. A computer-implemented method of performing a functional safety analysis of an integrated circuit device, the method comprising:
receiving, with a computing device, a user selection specifying functionality of the integrated circuit device to be considered in a functional safety analysis; and
automatedly performing, with the computing device, a functional safety analysis of the integrated circuit device that considers the functionality selected by the user.

11. The method of claim 10, wherein receiving a user selection specifying functionality of the integrated circuit device to be considered in a functional safety analysis comprises receiving a user selection specifying functionality of the integrated circuit device that are not to be considered in the functional safety analysis, and wherein automatedly performing a functional safety analysis comprises performing a functional safety analysis that does not consider the functionality which the user specifies are not to be considered.

12. The method of claim 10, wherein receiving a user selection specifying functionality of the integrated circuit device to be considered in a functional safety analysis comprises receiving a user selection specifying specific pins of the integrated circuit device that are to be considered in the functional safety analysis, and wherein automatedly performing a functional safety analysis comprises performing a functional safety analysis that considers the pins selected by the user.

13. The method of claim 10, wherein receiving a user selection specifying functionality of the integrated circuit device to be considered in a functional safety analysis comprises receiving a user selection specifying how many pins of a given functional module of the integrated circuit device are to be considered in the functional safety analysis, and wherein automatedly performing a functional safety analysis comprises performing a functional safety analysis that considers the number of pins selected by the user for the given functional module of the integrated circuit device.

14. The method of claim 10, wherein automatedly performing a functional safety analysis comprises calculating safety metrics of the integrated circuit device based on the functional safety analysis performed with respect to the functionality selected by the user.

15. The method of claim 14, further comprising:
comparing, with the computing device, a calculated safety metric of the integrated circuit device to a target safety metric; and
if the target safety metric is not achieved, automatedly changing, with the computing device, the user selection specifying functionality of the integrated circuit device to be considered in the functional safety analysis, and automatedly performing, with the computing device, a functional safety analysis based on the changed selection specifying functionality of the integrated circuit device to be considered in the functional safety analysis.

16. The method of claim 10, wherein automatedly performing a functional safety analysis comprises calculating estimated failure rate data for the integrated circuit device based on the functional safety analysis performed with respect to the functionality selected by the user.

17. The method of claim 10, wherein automatedly performing a functional safety analysis comprises calculating estimated failure rate data for specified functional modules of the integrated circuit device.

18. A computer-implemented method of performing a functional safety analysis of an integrated circuit device, the method comprising:
receiving, with a computing device, a user selection specifying diagnostic measures to be implemented in the user's system; and
automatedly performing, with the computing device, a functional safety analysis of the integrated circuit device taking into account the diagnostic measures selected by the user.

19. The method of claim 18, wherein the diagnostic measures selected by the user comprise diagnostic measures that are provided by the integrated circuit device.

20. The method of claim 18, wherein the diagnostic measures selected by the user comprise diagnostic measures that are provided by the user.

21. The method of claim 18, wherein automatedly performing a functional safety analysis comprises calculating safety metrics of the integrated circuit device based on the functional safety analysis performed based on the diagnostic measures selected by the user.

22. The method of claim 21, further comprising:
comparing, with the computing device, a calculated safety metric of the integrated circuit device to a target safety metric; and
if the target safety metric is not achieved, automatedly changing, with the computing device, the user selection specifying diagnostic measures to be implemented in the user's system, and automatedly performing, with the computing device, a functional safety analysis based on the changed selection specifying diagnostic measures to be implemented in the user's system.

23. The method of claim 18, wherein automatedly performing a functional safety analysis comprises calculating estimated failure rate data for the integrated circuit device based on the functional safety analysis performed taking into account the diagnostic measures selected by the user.

24. A computer-implemented method of performing a functional safety analysis of an integrated circuit device, the method comprising:
receiving, with the computing device, multiple sets of safety-related data for a given integrated circuit device, each set comprising data tending to have an effect on a failure rate of the integrated circuit device, and each set corresponding to a different safety-related configuration of the integrated circuit device;
automatedly performing, with the computing device, multiple functional safety analyses, each analysis based on a different one of the safety-related data sets, and each analysis calculating at least one safety metric for the corresponding safety-related data set; and
for each safety-related data set, comparing, with the computing device, a calculated safety metric to a target safety metric and designating the data set satisfactory if the target safety metric is achieved and non-satisfactory if the target safety metric is not achieved.

25. The method of claim 24 further comprising generating, with the computing device, a report for each safety-related data set, the report comprising an indication of whether each data set is designated satisfactory or non-satisfactory.

26. The method of claim 25, wherein the report further comprises calculated safety metrics for each safety-related data set.

27. The method of claim 24, wherein the safety-related data sets each comprise an indication of safety mechanisms activated for the integrated circuit device, and wherein each data set has different safety mechanisms activated.

28. The method of claim 24, wherein the safety-related data sets each comprise an indication of functional modules activated for the integrated circuit device, and wherein each data set has different at least one different functional module activated.

29. The method of claim 24 wherein the at least one safety metric calculated for each data set comprises a failure rate metric, and wherein comparing a calculated safety metric to a target safety metric comprises comparing the failure rate metric to a target failure rate metric, and wherein the corresponding data set is designated satisfactory if the target failure rate metric is achieved and non-satisfactory if the target failure rate metric is not achieved.
